(19) United States
(12) Patent Application Publication
(10) Pub. No.: US 2017/0038311 A1
(43) Pub. Date: Feb. 9, 2017

(54) RADIO FREQUENCY MATERIAL ANALYSIS UTILIZING PHASE

(71) Applicant: William Thomas Conrad, San Diego, CA (US)

(72) Inventor: William Thomas Conrad, San Diego, CA (US)

(21) Appl. No.: 14/816,891

(22) Filed: Aug. 3, 2015

(51) Int. Cl. G01N 22/00

(52) U.S. Cl. CPC G01N 22/00

(57) ABSTRACT

Briefly, embodiments of the present invention describe an inexpensive, accurate, rapid and automated method to detecting bubbles, foreign object, debris, dissimilar material or property changes in a liquid, lubricant, compressed gas or fine solid. This method uses the vector signal analysis [also known as a phase-gain meter or automatic network analysis] phase change in the transmitted energy versus the reflected energy in radio waves to detect bubbles, foreign object, debris, dissimilar material or property changes in a liquid, lubricant, compressed gas or fine solid using one, two or three antennas or a coil. This method describes the means by which to develop the specific sensor for the intended application. This method also describes the method by which to develop and tune a specific sensor for an exact application. This method also describes the type of sensor that would be used with the described method of detection. This method also describes the application of a sensor employing this method that includes: medical devices, printer ink, manufacturing/refining processes, industrial food processing, engine fuel monitoring, specific property sensing and lubricant property sensing.

### FIELD OF THE INVENTION

The present invention is directed to detect bubbles, foreign object, debris, dissimilar material or property changes in a liquid, lubricant, compressed gas or fine solid. The method works by observing the change in phase of the Radio Frequency transmitted energy versus the reflected energy using vector network analysis as the object of interest passes between an antenna and optional ground plane (or another antenna) or a coil of wire in proximity of the sampling area. This method may be used in medical devices, printer ink, manufacturing/refining processes, industrial food processing, engine fuel monitoring, specific property sensing and lubricant property sensing.

### BACKGROUND OF THE INVENTION

At present, bubbles, foreign object, debris, dissimilar material may be introduced into a liquid, lubricant, compressed gas or fine solid. In some cases it is necessary or advantageous to detect these objects. For example, an air bubble an Interventions liquid (IV) could cause an air embolism or a water globule could cause an engine to stop working. In addition, the properties of a material may change. For example a liquid may become thicker (more viscous). These material property changes can have serious effects on a system, process or person.

There are presently several methods for detecting bubbles, foreign object, debris, dissimilar material or property changes in a liquid, lubricant, compressed gas or fine solid. These include a sight glass where a person [or computer vision] looks for bubbles, foreign object, debris, dissimilar material or property changes in a liquid, lubricant, compressed gas or fine solid. Another is to use sound energy [ultrasonic] to detect the presence of bubbles, foreign object, debris, dissimilar material or property changes in a liquid, lubricant, compressed gas or fine solid. The ultrasonic method works by measuring the change of amplitude as the path from the ultrasonic transmitter to the receiver is disrupted by bubbles, foreign object, debris or dissimilar material. Some ultrasonic methods also use the Doppler Effect for detection. Another method is to pass white/colored light [or a laser] through the liquid, lubricant, compressed gas or fine solid and look for changes in the amount of light energy that is reflected or passed through the sample or the change in light spectrum of the passed through light. However this method does not work on opaque materials that completely block light such as ink. Another method is to use a conductive fluid and checks for continuity. When there is less continuity then a bubble, foreign object, debris or dissimilar material is present. However this only works on fluids that have consistent conductive properties. A variation of this method uses alternating current and checks for changes in capacitance. Another method is to use the RF signals and compare reflected energy or transmitted energy through a sample. A variation on this method is to send pulses of energy and analyze the returned pulses. In essence this is a miniature RADAR that passes energy through a sample and compares the returned energy or passed through energy.

While these present methods work, they have flaws. The optical methods suffer from requiring cleaning to ensure that the sensor is not detecting dirty optics. The RF amplitude and ultrasonic method does not always give repeatable results and are inflexible. The resistance/capacitance method does not always give repeatable results due to non-conductive build up on the plates.

What is needed is an inexpensive, accurate, rapid and automated method to detecting bubbles, foreign object, debris, dissimilar material or property changes in a liquid, lubricant, compressed gas or fine solid. This patent describes how observing the phase change of the Radio Frequency transmitted energy versus the reflected energy using vector network analysis in a liquid, lubricant, compressed gas or fine solid will show the presence of bubbles, foreign object, debris, dissimilar material or property changes. This method could be used in sensors for medical devices, printer ink, manufacturing/refining processes, industrial food processing, engine fuel monitoring, specific property sensing and lubricant property sensing.

### PATENT CITATIONS

US20130226130
U.S. Pat. No. 3,974,681
U.S. Pat. No. 4,312,341
U.S. Pat. No. 4,559,454
U.S. Pat. No. 4,631,529
U.S. Pat. No. 4,658,244
U.S. Pat. No. 4,763,525
U.S. Pat. No. 4,829,448
U.S. Pat. No. 4,884,065
U.S. Pat. No. 4,908,676
U.S. Pat. No. 5,116,759
U.S. Pat. No. 5,260,665
U.S. Pat. No. 5,274,335
U.S. Pat. No. 5,392,638
U.S. Pat. No. 5,534,708
U.S. Pat. No. 5,672,887
U.S. Pat. No. 5,680,111
U.S. Pat. No. 6,142,008
U.S. Pat. No. 6,515,487
U.S. Pat. No. 6,590,402
U.S. Pat. No. 6,750,468
U.S. Pat. No. 6,810,717
U.S. Pat. No. 7,661,293
U.S. Pat. No. 7,726,174
U.S. Pat. No. 7,815,612
U.S. Pat. No. 7,818,992
U.S. Pat. No. 7,981,082
U.S. Pat. No. 7,984,642
U.S. Pat. No. 7,987,722
U.S. Pat. No. 8,225,639
U.S. Pat. No. 8,646,309
U.S. Ser. No. 14/810,206

### SUMMARY OF THE INVENTION

Briefly, embodiments of the present invention describe an inexpensive, accurate, rapid and automated method to detecting bubbles, foreign object, debris, dissimilar material or property changes in a liquid, lubricant, compressed gas or fine solid. This method uses the vector signal analysis [also known as a phase-gain meter or automatic network analysis] phase change in the transmitted energy versus the reflected energy in radio waves to detect bubbles, foreign object, debris, dissimilar material or property changes in a liquid, lubricant, compressed gas or fine solid using one, two or three antennas or a coil. This method describes the means by which to develop the specific sensor for the intended application. This method also describes the method by which to develop and tune a specific sensor for an exact application. This method also describes the type of sensor that would be used with the described method of detection. This method also describes the application of a sensor employing this method that includes: medical devices, printer ink, manufacturing/refining processes, industrial food processing, engine fuel monitoring, specific property sensing and lubricant property sensing.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout different views. Others will be readily apparent to those skilled in the art.

FIG. 1 Phase Relationship;

FIG. 2 Block Diagram of Single Port Vector Network Analyzer [RF Phase Detector] Circuit;

FIG. 3 Block Diagram of Direct Single Port Vector Network Analyzer [RF Phase Detector] Circuit;

FIG. 4 Block Diagram of 2 Port Vector Network Analyzer [RF Phase Detector] Circuit;

FIG. 5 Block Diagram of Direct 2 Port Vector Network Analyzer [RF Phase Detector] Circuit;

FIG. 6 Block Diagram of Single Port Vector Network Analyzer [RF Phase Detector] Circuit to Coil;

FIG. 7 Block Diagram of Direct Single Port Vector Network Analyzer [RF Phase Detector] Circuit to Coil;

FIG. 8 Block Diagram of Simplified RF Phase Detection Circuit;

FIG. 9 Block Diagram of Simplified 74HCT9046 RF Phase Detection Circuit;

FIG. 10 Diagram of Antenna Sensor;

FIG. 11 Diagram of Antenna Sensor Inside Pipe or Tube;

FIG. 12 Diagram of Phase Test Data.

### DETAILED DESCRIPTION OF THE INVENTION

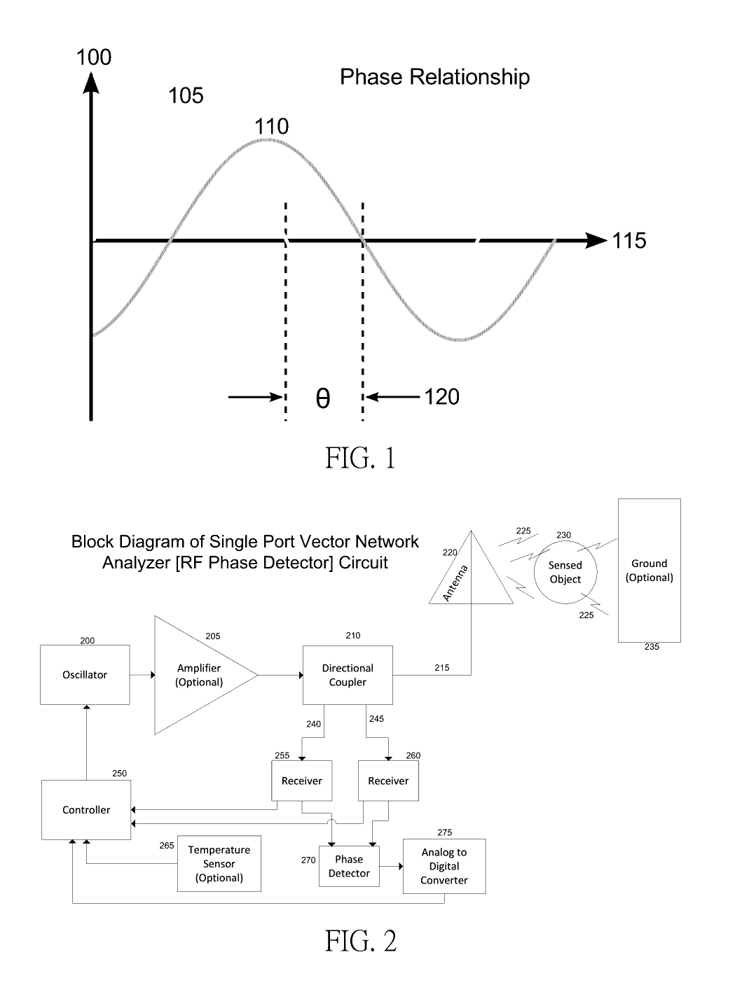

This patent describes an inexpensive, accurate and automated method to detecting bubbles, foreign object, debris, dissimilar material or property changes in a liquid, lubricant, compressed gas or fine solid. This method utilizes the vector network phase change in the transmitted energy versus the reflected energy in radio waves when bubbles, foreign object, debris, dissimilar material or property changes are present in a liquid, lubricant, compressed gas or fine solid. When a homogeneous [without bubbles, foreign object, debris, dissimilar material or property changes] liquid, lubricant, compressed gas or fine solid is normally flowing or standing still in front of the antenna [and optional ground or multiple antennas or coil of wire], there may be changes in the amplitude of the returned signal but generally little change in phase will be observed. When without bubbles, foreign object, debris, dissimilar material or property changes are passed in front of the antenna [and optional ground or multiple antennas or coil of wire], there may be changes in the amplitude of the returned signal but a pronounced change in phase will be observed at certain frequencies. This change in phase correlates to the presence of bubbles, foreign object, debris, dissimilar material or property changes. A vector network analyzer also known as a phase-gain meter or automatic network analyzer looks specifically at the amplitude and phase change between one or more signals at one or many radio frequencies. The theory behind this is that a change in the environment in front of the antenna will cause a change in impedance and this causes a pronounced affect in the phase domain. Every material has an electric permittivity and this is related by the Greek character epsilon (c). Epsilon affects and is affected by a dielectric medium. More electric flux exists in a medium with a high permeability (unit per charge) because of polarization effects. Permittivity relates to the material to transmit or permit an electric field. A bubble, foreign object, debris, dissimilar material or property changes will have a different permeability. This method may employ SWR (Standing Wave Ratio) which is the ratio of the amplitude of a partial standing wave at an antinode (maximum) to the amplitude at an adjacent node (minimum), in an electrical transmission line or in this case the antenna or coil of wire next to the area of where the sample (eg bubble) is being detected. An optional ground plane may complete the detection apparatus by proving an area of reflection for the transmitted energy. The SWR is usually defined as a voltage ratio called the VSWR, for voltage standing wave ratio. For example, the VSWR value 1.2:1 denotes a maximum standing wave amplitude that is 1.2 times greater than the minimum standing wave value. It is also possible to define the SWR in terms of current, resulting in the ISWR, which has the same numerical value. [Note: this method of detecting bubbles, foreign object, debris, dissimilar material or property changes is compatible with measuring the phase in the transmitted versus reflected current or wattage.] SWR is used as an efficiency measure for transmission lines, electrical cables that conduct radio frequency signals, used for purposes such as connecting radio transmitters and receivers with their antennas, and distributing cable television signals. A problem with transmission lines is that impedance mismatches in the cable tend to reflect the radio waves back toward the source end of the cable, preventing all the power from reaching the destination end. SWR measures the relative size of these reflections. An ideal transmission line would have an SWR of 1:1, with all the power reaching the destination and none of the power reflected back. An infinite SWR represents complete reflection, with all the power reflected back down the cable. In this method, what is observed in the difference in the phase between the transmitted energy and the reflected energy. Phase or phase difference is the difference, expressed in electrical degrees or time, between two waves having the same frequency and referenced to the same point in time. Two oscillators that have the same frequency and no phase difference are said to be in phase. Two oscillators that have the same frequency and different phases have a phase difference, and the oscillators are said to be out of phase with each other. The amount by which such oscillators are out of phase with each other can be expressed in degrees, radians, 0°-360°, +/−180 or 0-2π. Phase may also be represented by an arbitrary unit such as: 0-1 volt, 0-100%, 0-100 uS or 0-256 bits. For this method the unit(s) of phase measurement are not important; only that there is a measurable difference in the phase of the transmitted energy versus the reflected energy. Referring now to FIG. 1, we can see a plot of the phase of two signals. The amplitude of the signal is shown in (100) as the Y or vertical plot. This amplitude is measured in volts [or dB] representing the intensity of the transmitted energy and the reflected energy. This amplitude could also be in current or wattage. The transmitted signal is shown in (105). This is shown in this example figure as a sine wave but the actual signal could be any waveform. The reflected [in this diagram represented as out of phase] energy is shown in (110). In this diagram the reflected signal is shown with less amplitude a sine wave. The actual reflected signal may not be the same wave shape or intensity as the transmitted signal. The X or Horizontal axis (115) of this diagram shows time and this is related to frequency. The units of time are fractions of a second and change as the frequency changes. One would do testing to determine the best frequency to show the largest shift in phase and/or amplitude in the presence of the detected property. The difference in phase is shown in (120). Note that in the diagram, the phase is being measured at the zero crossing point however it could be measured at any point on the waveform such as the high or low point. This difference between the transmitted energy (105) and the reflected energy (110) is known as the phase. By measuring this phase at the frequency of interest, one can detect bubbles, foreign object, debris, dissimilar material or property changes in a liquid, lubricant, compressed gas or fine solid.

Obtaining the phase difference with analog circuits involves computing the arcsine and arccosine of each normalized input (to get an ever increasing phase) and then doing a subtraction. One type of analog phase detector is a quadrature phase detector that can be made by summing the outputs of two multipliers. The quadrature signals may be formed with phase shift networks. Two common implementations for multipliers are the double balanced diode mixer (diode ring) and the four-quadrant multiplier (Gilbert cell). Another method is to use a mixer-based detector (e.g., a Schottky diode-based double-balanced mixer). Both the quadrature and simple multiplier phase detectors have an output that depends on the input amplitudes as well as the phase difference. In practice, the input amplitudes are normalized. There are also analog integrated circuits that perform phase detection such as the Analog Devices AD8302. A digital phase detector may be made by using a square wave [the demodulated signal after the receiver] exclusive-OR (XOR) logic gate. When the two signals being compared are completely in-phase, the XOR gate's output will have a constant level of zero. When the two signals differ in phase by 1°, the XOR gate's output will be high for 1/180th of each cycle, the fraction of a cycle during which the two signals differ in value. When the signals differ by 180°; that is, one signal is high when the other is low, and vice versa. The XOR gate's output remains high throughout each cycle. The XOR detector compares well to the analog mixer in that it locks near a 90° phase difference and has a square-wave output at twice the reference frequency. The square-wave changes duty-cycle in proportion to the phase difference resulting. Applying the XOR gate's output to a low-pass filter results in an analog voltage that is proportional to the phase difference between the two signals. It requires inputs that are symmetrical square waves, or nearly so. The remainder of its characteristics are very similar to the analog mixer for capture range, lock time, reference spurious and low-pass filter requirements. Digital phase detectors can also be based on a sample and hold circuit, a charge pump, or a logic circuit consisting of flip-flops. When a phase detector that's based on logic gates is used in a Phase Locked Loop (PLL), it can quickly force the VCO to synchronize with an input signal, even when the frequency of the input signal differs substantially from the initial frequency of the VCO. Such phase detectors also have other desirable properties, such as better accuracy when there are only small phase differences between the two signals being compared. Another method is to take the received transmitted signal and received reflected signal after the receiver into an analog to digital converter then into a microprocessor/FPGA/ASIC. The digital processing can used an algorithm to do filtering, normalizing and precise phase detection.

There are many methods of making a single port radio frequency network vector [change of phase] circuit for this method. The main items in a vector network analyzer circuit are an oscillator, amplifier (if the inherent signal strength of the oscillator is sufficient, this can be eliminated), a directional coupler, a receiver, controller and a circuit to measure the phase. Referring now to FIG. 2, an oscillator is used to generate the RF frequency (200). In general the oscillated signal does not need to be complex for this method. A simple sine wave or sweeping sine wave will work well. However for more precise detection of bubbles, foreign object, debris, dissimilar material or property changes in a liquid, lubricant, compressed gas or fine solid, a different waveform may be used that is better suited for the testing environment or detected objects. There are many different forms of oscillators including an Armstrong (or Tickler or Meissner), Astable multivibrator, blocking, Butler, clapp, Colpitts, Delay line, dow (or ultra-audion), Hartley, Pierce, relaxation, RLC circuit, Royer, Va\check{c}ká\check{r}, Wien bridge, voltage controlled oscillator (VCO), sweep, synthesized [using an digital to analog converter controlled by an FPGA, (also known as CPLD, PLD, PAL) microprocessor, microcontroller, ASIC, DSP, or ROM] or crystal oscillator. For this application a sine, sweep or Voltage Controlled Oscillator (VCO) is ideal. The frequency of the oscillator depends on the types of parent material (eg liquid) and the type bubbles, foreign object, debris, dissimilar material or property changes in a liquid. After the oscillator is an optional RF amplifier (205). This application normally uses a low amount of Radio Frequency energy but in the event that this energy or signal level is not enough for the application, an RF amplifier may be used to boost the signal. After the amplifier, the signal is passed through a directional coupler (210). The directional coupler is a passive device gives a representation of the transmitted energy (235) and the reflected energy (240). Directional couplers are most frequently constructed from two coupled transmission lines set close enough together such that energy passing through one is coupled to the other. This technique is favored at the microwave frequencies. However, lumped component devices are also possible at lower frequencies. At microwave frequencies, particularly the higher bands, waveguide directional couplers can be used. Many of these waveguide couplers correspond to one of the conducting transmission line designs, but there are also types of directional couplers that are unique to waveguide. There are many types of directional coupler depending on the frequency, precision and amount of power. This includes: Coupled transmission lines, branch-line coupler, Wilkinson power divider, hybrid ring coupler, waveguide branch-line coupler, Bethe-hole directional coupler, Riblet short-slot coupler, Schwinger reversed-phase coupler, 90° hybrid coupler or a Moreno crossed-guide coupler. A simple directional coupler can be made with a resistor to provide a higher impedance source separated from a low impedance source. After the directional coupler, the signal passes through a wire, coax cable or waveguide (215) depending on the frequency or application. The signal then passes to an antenna (220) that emits radio waves (225) in the presence of the sensed object (230) [eg a tube] and is then reflected against an optional ground (235). The optional ground may be important as it can be used to control the reflected impedance to a normalized range. The antenna (220) size and type depends on the size of the area to be measured [eg tube], the property that is being detected (bubbles, foreign object, debris, dissimilar material or property changes) and the parent material (liquid, lubricant, compressed gas or fine solid.) An example antenna would be a small conductive flat plate of 1 cm by 4 cm. The sensed object should be between this and the optional ground plane. It is ideal to have minimal space between the antenna, sensed object and optional ground. As bubbles, foreign object, debris, dissimilar material or property changes pass through a liquid, lubricant, compressed gas or fine solid, the phase and/or amplitude of the radio waves will change in the transmitted energy compared to the reflected energy. This change of phase will be present in the signal output of the directional coupler (210). The transmitted energy (240) will be sent to a receiver (255) to demodulate the signal. The receiver takes the RF frequency and converts it to a signal compatible with the phase detector. Some receivers may have an amplifier stage before the receiver to boost the signal to the receiver for better sensitivity. There are several types of receivers including: AM, heterodyne, superheterodyne, phase locked loop, digital (Also known as a software defined radio and this uses an analog to digital converter that sends the digital information to a DSP/microprocessor/FPGA/ASIC), Gunn diode, crystal, neutrodyne, regenerative or direct conversion. The reflected energy (245) from the directional coupler (210) is sent through a receiver (260). The receivers and oscillator are controlled by an analog circuit or digital controller (250). The function of the controller is to select one or many frequencies of interest by controlling the oscillator, transmitted energy receiver and the reflected energy receiver together. The controller can be a microprocessor, microcontroller, DSP, ASIC or FPGA. The controller may be a simple type that fixes the oscillator and receivers to a single value and reports the phase output. The controller can sweep frequencies slowly or rapidly depending on the application. The signals out of the receivers (255), (260) are sent to a phase detector (270) and the output of the phase detector represents the presence (or non-presence) of bubbles, foreign object, debris, dissimilar material or property changes in a liquid, lubricant, compressed gas or fine solid. The analog output of the phase detector is sent to an analog to digital converter (275). This digital output is then sent to the controller. The controller can used an algorithm to have additional processing such as a peak detector, low pass filter, first (or second) derivative to look for rate of change in the signal over time. The control of the system could also be supplemented with an optional temperature sensor (265) to improve detectability and accuracy. Ideally the temperature sensor would sense the liquid, lubricant, compressed gas or fine solid. The change in density will affect the degree of phase and frequency of interest. With some experimentation the change of phase and frequency of interest can be identified and correlated to temperature. This information can then be applied to adjust the algorithm detection parameters to further improve accuracy and could also be used to adjust frequency, signal strength and waveform shape. In addition to temperature, the other properties of the liquid, lubricant, compressed gas or fine solid can be applied to improve detectability and accuracy. This can include pressure, PH, humidity (for fine solid), conductivity, capacitance, density or sound propagation. Like temperature, this information can then be applied to adjust the algorithm detection parameters to further improve accuracy and could also be used to adjust frequency, signal strength and waveform shape.

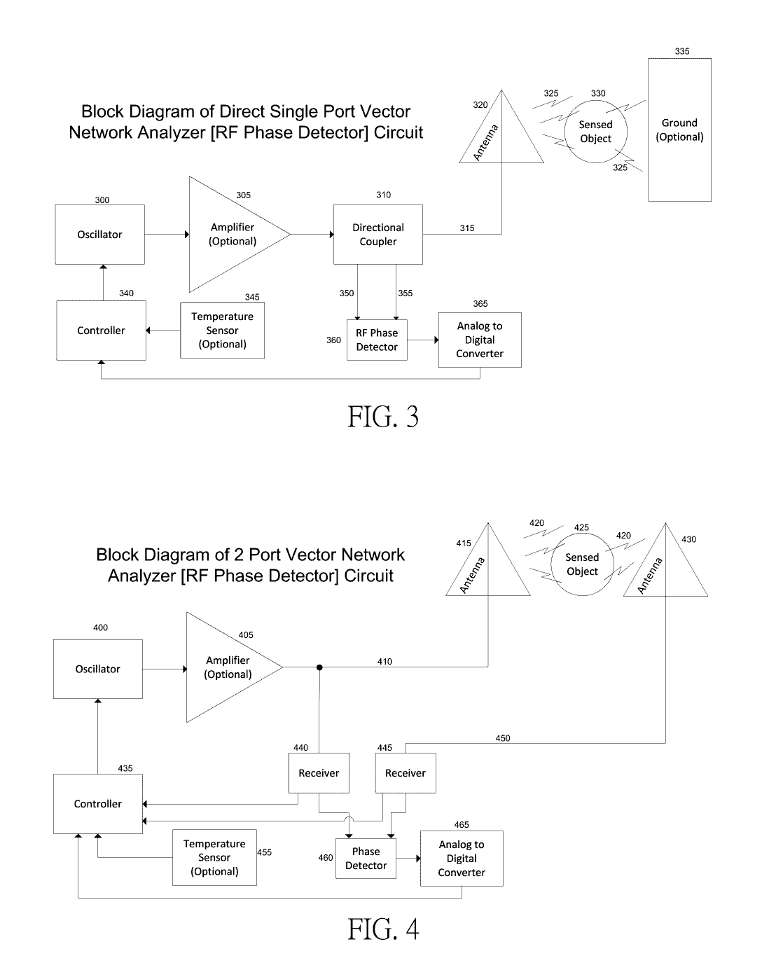

Another method of one can detect bubbles, foreign object, debris, dissimilar material or property changes in a liquid, lubricant, compressed gas or fine solid at the frequency of interest is to use a direct single port radio frequency network vector [change of phase]. The advantage of this method is that the receiver(s) may be eliminated. Referring now to FIG. 3, like the (200) method, a controller (340) sends a signal to an oscillator (300) is used to generate the RF frequency, and this passes through an optional RF amplifier (305) to a directional coupler (310), to a wire, coax or waveguide (215) and to an antenna (320). The antenna radiates radio energy (325) through the sensed object (330) and to an optional ground plane (335). The difference between method (200) and this is the transmitted energy (350) and the received energy (355) is sent directly to a RF phase detector (360) and then to an analog to digital converter (365) then to the controller (340). The phase detector must be sensitive enough to be able to operate at the levels that the oscillator and optional amplifier are operating at. If this is not the case, an amplifier may be used to boost the signal into the RF phase detector. This method also has an optional temperature sensor (345).

Another method of one can detect bubbles, foreign object, debris, dissimilar material or property changes in a liquid, lubricant, compressed gas or fine solid at the frequency of interest is to use a two port radio frequency network vector [change of phase]. This circuit is nearly identical to a single port circuit except that there is no directional coupler and the optional ground may be eliminated. The advantage of this circuit is better coupling which leads to more sensitive detection. Referring now to FIG. 4, an oscillator is used to generate the RF frequency (400). After the oscillator is an optional RF amplifier (405). The signal then passes to an a wire, coax or waveguide (410) then to an antenna (415) that emits radio waves (420) in the presence of the sensed object (425) and is then received by the receiving antenna (430). Radio waves will pass through the sensed object from the antenna to the receiving antenna. As bubbles, foreign object, debris, dissimilar material or property changes pass through a liquid, lubricant, compressed gas or fine solid, the phase of the radio waves will change the passed through energy from one antenna (415) to the other antenna (430). The transmitted energy will be sent to a receiver (440) to demodulate the signal. Note that the receiver may need to have an attenuator to prevent front end overload. The received energy will be pass through a wire, coax or waveguide (450) then to a receiver (445) to demodulate the signal. The receiver takes the RF frequency and converts it to a signal compatible with the phase detector. The receivers and oscillator are controlled by an analog or digital controller (435). The function of the controller is to observe one or many frequencies of interest. The signals out of the receivers are sent to a phase detector (460) and the output of the phase detector is sent to an analog to digital converter (465) then to the controller (435). This method also has an optional temperature sensor (465).

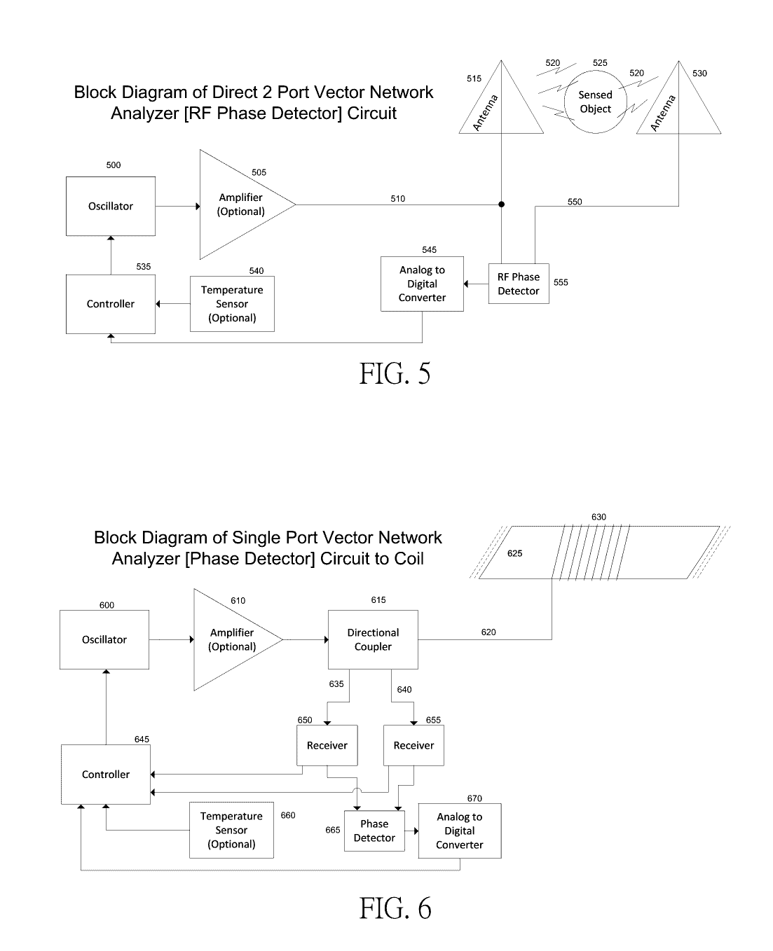

Another method of one can detect bubbles, foreign object, debris, dissimilar material or property changes in a liquid, lubricant, compressed gas or fine solid at the frequency of interest is to use a direct two port radio frequency network vector [change of phase]. This circuit is nearly identical to a two port circuit (400) except that there is no receiver. The advantage of this circuit is lower cost by the elimination of the receiver. Referring now to FIG. 5, an oscillator is used to generate the RF frequency (500). After the oscillator is an optional RF amplifier (505) then the signal is sent to a wire, coax or waveguide (510) then to an antenna (515) that emits radio waves (520) in the presence of the sensed object (525) then received by the receiving antenna (530) and then through a wire, coax or waveguide (550). Radio waves will pass through the sensed object from the antenna to the receiving antenna. The transmitted energy (510) and the received energy (550) are sent to a RF phase detector (555) and the output of the phase detector is sent to an analog to digital converter (545) and then to the controller (535). The phase detector must be sensitive enough to be able to operate at the levels that the oscillator and optional amplifier are operating at. If this is not the case, an amplifier may be used to boost the signal into the RF phase detector. This method also has an optional temperature sensor (555).

Another method of one can detect bubbles, foreign object, debris, dissimilar material or property changes in a liquid, lubricant, compressed gas or fine solid at the frequency of interest is to use a single port radio frequency network vector [change of phase] that is connected to a coil as opposed to an antenna. The advantage of this method is that it operates at a lower frequency and this may use lower cost parts. Another advantage is that this method will detect the magnetic properties of the liquid, lubricant, compressed gas or fine solid. The method described in FIGS. 2 through 5 relies on the electrical properties of the material through the use of an antenna while this method relies on the magnetic properties of the material through the use of a coil. The theory behind this is that a change in the environment [ie a pipe] within the coil of wire will cause a change in impedance and this causes a pronounced affect in the phase domain. Every material has magnetic permittivity and this is represented by the Greek character μ. The permeability constant (μ), also known as the magnetic constant or the permeability of free space, is a measure of the amount of resistance encountered when forming a magnetic field. A closely related property of materials is magnetic susceptibility, which is a measure of the magnetization of a material in addition to the magnetization of the space occupied by the material. This coil of wire sensor is known as a B field sensor. Referring now to FIG. 6, like the method described in FIGS. 2 through 5, a controller (645) sends a signal to an oscillator is used to generate the RF frequency (600), and this passes through an optional RF amplifier (610) to a directional coupler (615) to a wire or coax (620) and then to a coil of wire (630) wrapped around the sensed object (625) [ie a pipe]. Note that the coil of wire wrapped around the pipe should not be coax cable and should not be electrically connected to the object. This sensed object [ie a pipe] should ideally be non-conductive as not to contribute to the magnetic effect of the coil. The transmitted energy (635) and the received energy (640) go to receivers (650) (655) and then to a phase detector (665). The output of the phase detector would go to an analog to digital converter (670) and then to the controller (645). This method also has an optional temperature sensor (660).

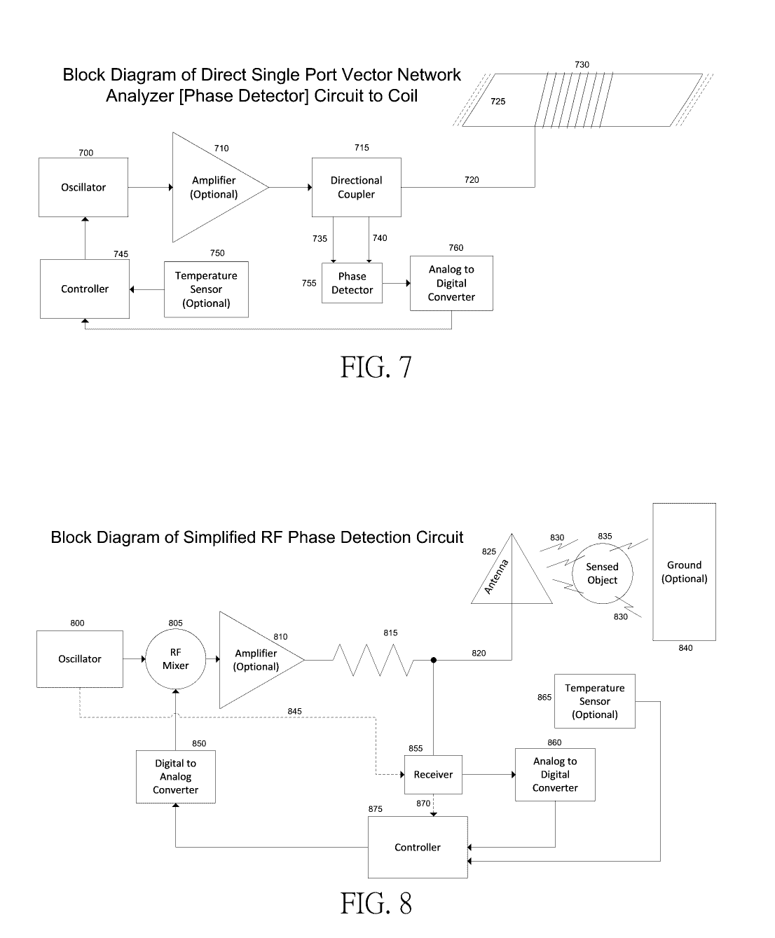

Another method of one can detect bubbles, foreign object, debris, dissimilar material or property changes in a liquid, lubricant, compressed gas or fine solid at the frequency of interest is to use a direct single port radio frequency network vector [change of phase] that is connected to a coil with no receivers. The advantage of this method is that it there is less parts with the elimination of the receiver. Referring now to FIG. 7, like the (600) method, a controller (745) sends a signal to an oscillator is used to generate the RF frequency (700), and this passes through an optional RF amplifier (710) to a directional coupler (715) through a wire or coax (720) then to a coil of wire (730). The coil of wire would be wrapped around the sensed object (725) [ie a pipe]. The transmitted energy (735) and the received energy (740) go to a RF phase detector (755) which is sent to an analog to digital converter (760) then to the controller (745). The phase detector must be sensitive enough to be able to operate at the levels that the oscillator and optional amplifier are operating at. If this is not the case, an amplifier may be used to boost the signal into the phase detector. This method also has an optional temperature sensor (760).

A simplified version of a dedicated single port radio frequency network vector [change of phase] detection circuit may be made with a digital controller and some RF components. The advantage of having a processor do this is that the receiver for the transmitted energy can be eliminated from the design. Referring now to FIG. 8, the process starts by the controller (875) generating a digital waveform that is sent to the digital to analog converter (850). This is because the controller (850) has direct control over the modulated signal and the output from the controller would represent the modulated transmitted energy exactly. The modulated waveform may be a sine, pulse, delta, square or other waveform that is either a fixed frequency or swept through a range of frequencies. The output of the digital to analog converter is sent to an RF mixer (805). An RF mixer adds the signal on top of the oscillated signal to generate a modulated RF signal. Note that the controller could connect directly to the mixed without the digital to analog converter by making a square wave output. There is an oscillator (800) that generates a primary frequency. The oscillator frequency of choice is dependent on the types of parent material and the type of bubbles, foreign object, debris, dissimilar material or property changes of interest and the antenna type/size. After the mixer is an optional RF amplifier (810). This signal is then passed through a directional coupler [in this case a resistor] (815) that allow a limited current to pass through, proportional to the load that is placed on its output. The signal then passes from the directional coupler to a wire, coax or waveguide (820) an antenna (825) that emits radio waves (830) in the presence of the sensed object (835) and is then reflected against an optional ground plane (840). The reflected energy is sent to a receiver (855) and then the output of the receiver is sent to an analog to digital converter (860). Alternatively, the receiver output signal could go directly to the controller's digital input (870). This would not be as accurate but reduce the cost of the circuit. An optional more stable circuit would use the oscillator to provide its primary frequency to the receiver for more accuracy (840). The analog to digital converter takes the demodulated signal and converts it to a digital stream of data that is sent to the controller (875). This digital stream is then processed by the controller using an algorithm. A typical algorithm starts by filtering the initial signal with a low pass or filter to remove noise. However if the design is stable enough, this step may be eliminated. The algorithm would then compare the entire signal a measure the average DC offset and remove this with an addition or subtraction. However if the design is stable enough, this step may be eliminated. The algorithm would then take the average peak values and apply a multiplication to make the signal uniform. However if the design is stable enough, this step may be eliminated. The algorithm would then do a phase comparison of the signal that the algorithm generated [this is represented by the output of the A-D (860)] and the reflected signal looking at both zero crossing point. There would be some calibration done in advance to adjust for the time [delay] that is required for the length of wire to the antenna, processing, analog to digital, digital to analog, voltage controlled oscillator and the receiver. This time would be subtracted from the phase measurement to give a corrected phase. Additional averaging could also be applied to further improve accuracy and reduce false signals. When the this algorithm detects a change of phase this would indicate the presence of bubbles, foreign object, debris, dissimilar material or property changes in a liquid, lubricant, compressed gas or fine solid. The algorithm can be set for a fast change in phase and ignore a slow change in phase or vice versa. This method also has an optional temperature sensor (865).

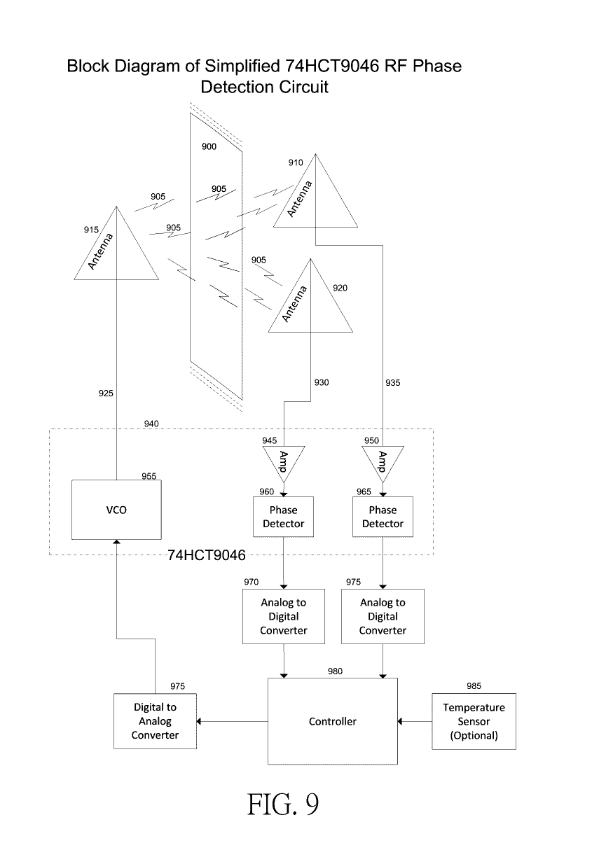

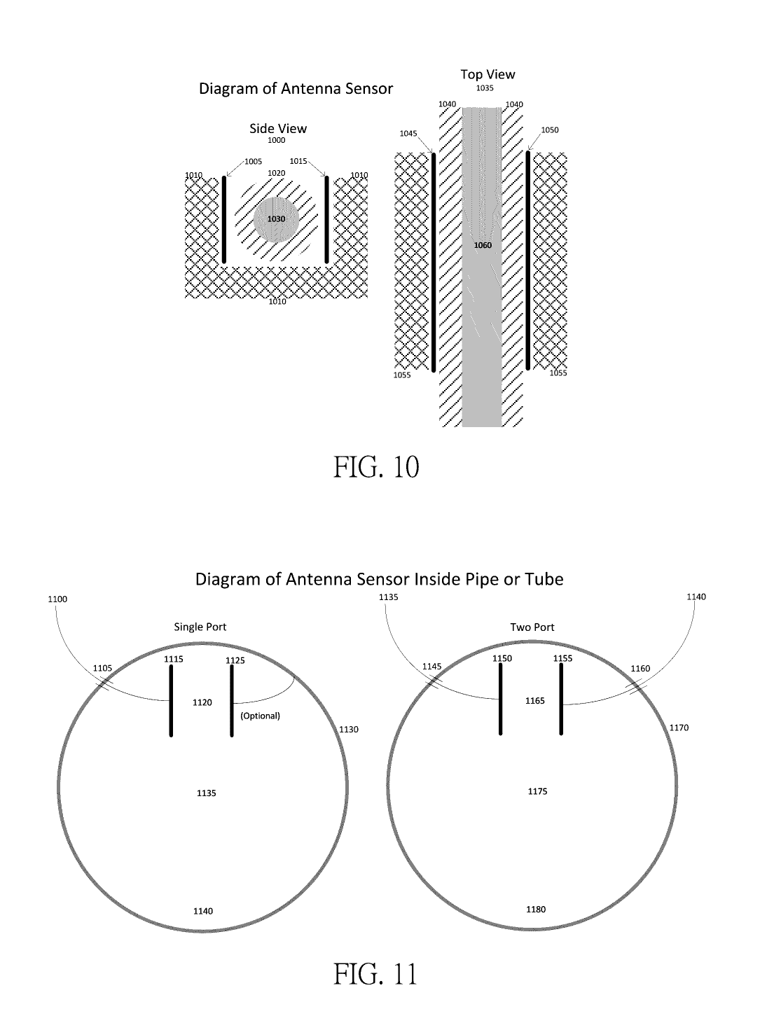

A simplified version of a dual/triple port radio frequency network vector [change of phase] detection circuit may be made with a 74HCT9046 (or similar integrated circuit.) Referring now to FIG. 9, a PLL with band gap controlled VCO integrated circuit [74HCT9046] is set up to determine if bubbles, foreign object, debris, dissimilar material or property changes are present in a liquid, lubricant, compressed gas or fine solid. The 74HCT9046 (940) has two phase detector circuits built in. This allows for three different configurations. The first is to have one antenna observing a sample area that will never have a bubbles, foreign object, debris, dissimilar material or property changes and this would be used as a control to show the amount of phase offset generated by the environment. The second configuration would be to observe the sample area with two antenna's. If the controller observed a signal from one sensor but not the other, this could be a false positive and the controller could eliminate this occurrence. If the change of phase was detected in both phase detectors then the controller would have a confident result. The controller would also know which direction the bubbles, foreign object, debris, dissimilar material or property changes are passing depending on which antenna had the change of phase first. The third configurations could have a two different receiving antennas to look for different properties in the sensor area.

The circuit is set up by having a controller set a fixed or sweep frequency and observe the phase difference. The controller (980) first sends a digital signal to the D-A (975) and this generates a voltage that controls the voltage controlled oscillator (955) within the 74HCT9046. The VCO (955) generates an RF output that is sent through a wire or cable (925) to an antenna (915). The RF energy (905) from the antenna passes through the sample (900) [ie a pipe] and then to either one or both receiving antenna's (910), (920). The output of the first antenna (920) is sent through a wire or coax (930) and then to an amplifier (945) inside the 74HCT9046 and this is sent to a phase detector (960) inside the 74HCT9046 which compares the phase of the VCO (955) to the received signal (945). The output of the phase detector (960) is sent to and A-D converter (970) and this is sent to the controller (980). If a second antenna is used (910), it's signal would pass through a wire or coax cable (935) be sent to an amplifier (950), then to a phase detector (965), then an A-D (975) and then into the controller (980). Optionally the controller can have a temperature sensor (985) to compensate for temperature affects.

The sensor that is used to determine if bubbles, foreign object, debris, dissimilar material or property changes are present in a liquid, lubricant, compressed gas or fine solid depends on the specific application. Referring now to FIG. 10, is an example of a sensor side view (1000) and top view (1035) that would be used outside of a pipe or tube. The housing of the sensor side view (1010) top view (1055) would be made of a material that isolates the pipe or tube from the surrounding area. An ideal nonconductive substance would be Teflon but other nonconductive substances would also work. The sensor antenna side view (1005) top view (1045) would be made of a conductive material such as copper. The area of the antenna would depend on the application but should extend slightly above and below the pipe or tube. The antenna could be contoured around the pipe or tube. The antenna would be attached to the circuit output [like (215)] with wire, coax or waveguide. On the other side is either the optional ground [like (235)] or second antenna [like (430)] for a two port vector network analyzer. The second ground or antenna side view (1015) top view (1050) would be made out of the same conductive material as the antenna. The outside of the pipe or tube side view (1020) top view (1040) would be made of a nonconductive material that allows radio waves to penetrate the pipe or tube. The inside of the pipe or tube side view (1030) top view (1060) would contain the liquid, lubricant, compressed gas or fine solid. Some experimentation would have to be done to compensate for the pipe or tube properties in the area of frequency and phase shift level. It is important to note that this sensor type allows the tube to be removed and another tube to be placed back in. This is important for intravenous fluid applications where the tube must remain sterile.

Another type of sensor could be placed inside a pipe, tube, tank or vessel or be made into a probe that could be inserted into a liquid, lubricant, compressed gas or fine solid. Referring now to FIG. 11, is an example of a sensor that would be used inside a pipe, tube, tank or vessel (1130) two port (1170). The vector network phase detector circuit is connected to a single port wire or coax cable (1100) or two port wire or coax cable (1135) to the single port antenna (1115) or two port antenna (1150). The wire or coax cable enters into the tube or pipe through a feed-through single port (1105) or two port feed-through (1145), (1160) that prevents anything [other than the electrical signal to the antenna] from leaving or entering the single port pipe or tube (1130) or two port pipe or tube (1170). The single port antenna (1115) or two port antenna (1150) is placed near the optional ground (1125) or receiving antenna in a two port application (1155) and bubbles, foreign object, debris, dissimilar material or property changes are detected within this single port area (1120) or two port area (1165). The optional ground (1125) would be electrically connected to the pipe or to a ground connection on the feed-through. Note that the optional ground plane could be the inside of a conductive pipe. The receiving port of a two port application would be connected to the vector network analyzer (1140). Alternatively the sensor could be placed in the center (1135) or two port center (1175) or at the bottom (1140) or two port bottom (1180). This would allow the detection of and bubbles, foreign object, debris, dissimilar material or property changes that occur at the middle or bottom of the pipe, tube, tank or vessel. This allows the detections of bubbles, foreign object, debris, dissimilar material or property changes that are the same density, lighter or heavier than the liquid, lubricant, compressed gas or fine solid. Note that the pipe, tube, tank or vessel in this example could be made out conductive or non-conductive material. If non-conductive pipe material is used, the optional ground must be connected to the feed-through to the vector network circuit.

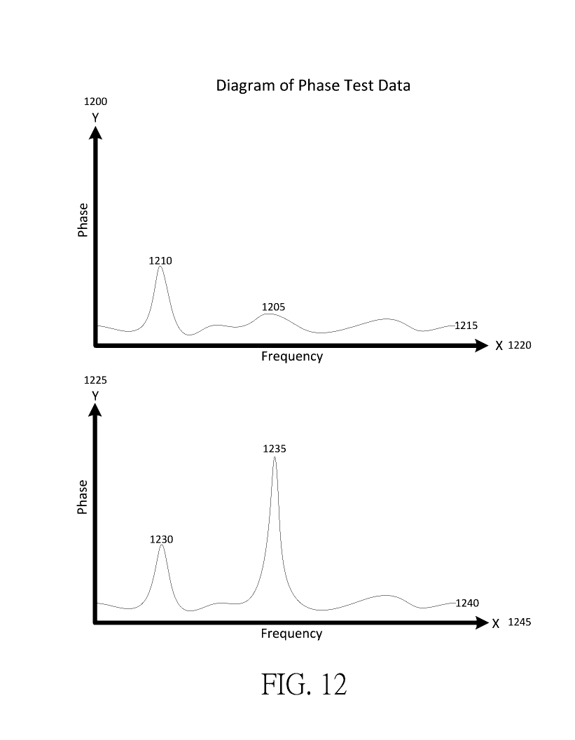

In order to determine what frequency and how much phase shift will occur when bubbles, foreign object, debris, dissimilar material [or property changes] pass through a liquid, lubricant, compressed gas or fine solid, some experimentation is required. This can be accomplished in two ways. The first is to use an instrument that operates over a wide frequency range and the second is to build one or many circuits over a specific range to measure the amplitude and/or phase. The first method is ideal due to the fast setup. The instrument of choice is a single, dual or triple port vector network analyzer such as the Rohde & Schwarz ZVA40. A network analyzer will allow the user to sweep over a wide frequency range and show the exact amount of phase at a specific frequency. To start this process, the user would set up the antenna (or coil) next to the item of interest [for example a pipe or tube] and the optional ground plane. The antenna (or coil) and optional ground would then be connected to the network analyzer. The vector network analyzer would be setup in a sweep configuration and when bubbles, foreign object, debris, dissimilar material [or property changes] pass through a liquid, lubricant, compressed gas or fine solid a phase shift would occur at a specific frequency. The user could then experiment with different sizes or types of bubbles, foreign object, debris, dissimilar materials [or property changes] to see the different amounts of phase shift and frequencies of interest. Once the ideal frequency or sweep of frequency is determined, the user could experiment with different waveforms (sine square, pulse, delta) to select the most ideal to show a pronounced phase effect. Referring now to FIG. 12, are two example phase versus frequency plots that would be generated by a radio frequency vector network analyzer or swept frequency phase circuit. In both plots the vertical or Y axis depicts the amount of phase shift (1200), (1225) and the horizontal or X axis depicts frequency (1220), (1245). First a reference sample is made with no bubbles, foreign objects, debris, dissimilar material or property changes are in front of the antenna or coil. A sweep is made over a select frequency range and the phase versus frequency results are plotted (1215). In this diagram, there is a detected phase shift at (1210) and this relates to a phase shift that is made by the circuit, wire, coax or waveguide, antenna or sample [eg pipe]. In the second phase versus frequency plot, a bubble, foreign object, debris, dissimilar material or property changes is introduced and the results plotted (1240). The same phase shift occurs (1230) as the first plot (1210) and this confirms that the first phase shift (1210) was not caused by a bubble, foreign object, debris, dissimilar material or property changes. However an additional phase change occurs at (1230) and this indicates that a bubble, foreign object, debris, dissimilar material or property changes caused the second phase shift. One would use this frequency and amount of phase shift to confirm the present of bubbles, foreign object, debris, dissimilar material or property changes in future samples. If a dual port sensor is used the process is the same except that instead of the optional ground plane, a second antenna would be connected to the vector network analyzer. If a third antenna in needed, it would be connected to the third port on a vector network analyzer. The user could also experiment with different antenna configurations to get optimal performance to analyze the area of interest. The user could also correlate how the temperature of the sensed material affects the frequency of interest and the phase change to analyze the area of interest. Once the experiment is complete with the vector network analyzer, a specific radio frequency phase detection circuit could be made to analyze the area of interest. The dedicated RF circuit would also have to go through additional tuning as the impedance between a network analyzer and custom circuit may differ slightly. If the circuit uses a microprocessor, DSP, ASIC or FPGA, further tuning or code changes would be required to eliminate false positives and negatives.

### APPLICATIONS OF THIS INVENTION

This method of detecting bubbles, foreign object, debris, dissimilar material or property changes pass through a liquid, lubricant, compressed gas or fine solid has several applications. They include medical devices, printer ink, manufacturing/refining, industrial food processing, engine fuel monitoring, specific property sensing and lubricant property sensing.
1. It is critical that no bubbles or foreign debris be introduced into a patent's [or animal] fluids. Bubbles or foreign debris may be introduced medical equipment that works with biological fluids [IE IV pump or a heart lung machine]. Introduction of an air bubble could cause an “air embolism” which could cause serious medical consequences. A sensor using this method could detect bubbles or foreign debris an IV fluid, blood line or device implanted into a patent that handles fluids. An advantage of this method is that the RF signals will pass through the IV fluid tube without piercing the tube. In this way the IV/tube may be inserted and removed from the sensor while remaining sterile. Once a bubble or foreign debris is detected, the sensor could alert medical personnel, stop the fluid flow or automatically purge out the bubble(s) or foreign debris.
2. In a print head it is critical to keep a steady supply of ink free from bubbles or debris. A bubble can disrupt the flow of ink which prevents the print head from printing. In some instances the flow may be restored from a bubble by a cleaning cycle and some instances the flow cannot be restored and the print head must be replaced. Debris can also disrupt the flow of ink but it is unlikely that a cleaning cycle can restore proper printer operations once debris has clogged the print head. By using this method to develop a sensor, the printer can either automatically purge the bubbles before they become in contact with the print head and this would eliminate unnecessary cleaning cycles saving ink and time. Alternatively, the printer could be automatically stopped and the operator could purge the bubbles or debris manually. In addition this method may be used in the manufacture of print heads to ensure that no bubbles or debris are introduced into the print cartridge.
3. In manufacturing/refining it is often important to have constancy in a process. Bubbles, foreign object, debris, dissimilar material or property changes contained within a liquid, lubricant, compressed gas or fine solid can disrupt production and/or lead to a poor quality product. This wastes money, resources and leads to customer dissatisfaction. By using a sensor with this method to detect bubbles, foreign object, debris, dissimilar material or property changes contained within a liquid, lubricant, compressed gas or fine solid, this issue can be eliminated. Testing would have to be done to optimize a sensor for the specific manufacturing applications. The result is that the unwanted material or unwanted material condition can be purged automatically (or with operator intervention) or the process could be stopped before the bubbles, foreign object, debris, dissimilar material or property changes cause an issue.
4. In industrial food processing, it is important to have process constancy. Having bubbles, foreign object, debris, dissimilar material or property changes contained within a liquid, food, compressed gas or fine solid can disrupt production and lead to a poor quality food product. In addition air bubbles within food could lead to unwanted bacteria/germ growth, fermentation or unsightly food. By using a sensor with this method to detect bubbles, foreign object, debris, dissimilar material or property changes contained within a liquid or food, this issue can be eliminated. Testing would have to be done to optimize a sensor for the specific food processing applications. The result is that the unwanted material or condition can be purged automatically (or with operator intervention) or the process could be stopped before the bubbles, foreign object, debris, dissimilar material or property changes cause an issue with food production.
5. In a combustion application, it is essential to have a steady flow of quality fuel. Fuel that has bubbles, foreign object, debris, ice or water could cause an engine/boiler/turbine/fuel cell/rocket/reactor to stop, stall, sputter or become damaged. In an environment requiring high reliability [like an aircraft] the results of bubbles, foreign object, debris, ice or water in the fuel have led to fatalities. By using a sensor with this method to detect bubbles, foreign object, debris, ice or water in fuel, this issue can be eliminated. Testing would have to be done to optimize a sensor for the specific engine/fuel applications. The result of detecting bubbles, foreign object, debris, ice or water by observing phase change is that the unwanted material or condition can be purged automatically (or with operator intervention) or the engine could be automatically stopped to prevent damage.
6. In an environment where it is important to monitor/determine the specific properties of a material, this method could be utilized. An optimized sensor could be made that observes a sample for specific property changes. The property changes would be related to consistency, density, a mixture with ratios of different materials that have different densities [IE emulsions] or the presence of bubbles. If the material properties changes such as density or consistency, the phase change would be apparent. The different properties would also have different signatures in phase, amplitude and frequency. As the output of the sensor is a phase change and this is represented as a numerical magnitude, subtle property changes can be detected and corrected. One could use this information to monitor a process and change the process as the phase changes thereby correcting the process to have consistent results. One could also use a dedicated vector network analyzer to analyze property changes with great precision. One could also dedicate an analog or digital circuit to look for specific variations in the properties of a material.
7. In an environment where a lubrication is used it is important to determine the lubricant properties. A lubricant can have: viscosity, lubricity, pour point and cloud point. A lubricant can also have a mixture of carbon/dirt/metal partials mixed in, water/coolant or additives [anti corrosion, thermal stabilizers, thickener, filler, dyes or de-emulsify]. It is important in manufacturing to precisely control lubricant properties and an optimized sensor could be made to sense one or more properties for quality control. Once the lubricant is in use, it is important for the user to determine if the lubricant is of the proper type and does not contain unwanted material. A hand held or fixed sensor could be developed using this method to sense one or more properties of the lubricant. Once the lubricant is in place [ie an engine] it is important to monitor the health of the lubricant. Over time containments may be introduced and the lubricant can break down. A sensor could be developed using this method to monitor one or more properties of the lubricant. When the lubricant is determined to be out of specification the controller could alert the operator, stop the equipment or preform an automatic lubrication change. A specific application of this method is the lubrication [oil] that is used in an internal combustion engine. Engine lubricant can lose viscosity, become contaminated with soot, coke, water/coolant and metal particles during normal operation. Depending on the engine usage [IE hard driving] or brand of lubricant, the useful life of the lubricant will vary and thus lubrication changes will occur at different intervals. A sensor could be developed using this method to monitor one or more properties of the lubricant. With this information, the operator of the engine could be prompted with an estimated life of the lubricant or prompted to change the oil. In addition if the lubricant was bad enough to cause damage to the engine, the controller could prevent engine starting.

What is claimed is:

1. A method to detect bubbles, foreign object, debris, dissimilar material or property changes in a liquid, lubricant, compressed gas or fine solid by observing the radio frequency change of phase in a single port [and optional ground plane], two port or three port network vector in the transmitted versus reflected signal of radio frequency energy applied to an antenna(s) near the sample area or a single applied to a port coil of wire around the sample area to detect bubbles, foreign object, debris, dissimilar material or property changes in a liquid, lubricant, compressed gas or fine solid with applications that include medical devices, printer ink, manufacturing/refining processes, industrial food processing, fuel monitoring, specific property sensing and lubricant property sensing.

2. An method that that utilizes radio frequency network vector [change of phase] in the transmitted energy versus reflected energy on a single port, two port or three port antenna or coil around the sample are to detect the presence of soot, coke, water/coolant, metal particles, bubbles, foreign object, debris or property changes [viscosity, lubricity, pour point or cloud point] in an internal combustion engine lubricant.

3. A sensor that employs one or more antenna(s) and optional ground plane mounted outside a pipe/tube/sample area, inside a pipe/tube/sample area or a coil of wire around the pipe/tube/sample area that would be attached to a radio frequency network vector [change of phase] circuit measuring the change in phase of the transmitted energy compared to the reflected energy to detect bubbles, foreign object, debris, dissimilar material or property changes in a liquid, lubricant, compressed gas or fine solid.
